(19) United States
(12) Patent Application Publication
(10) Pub. No.: US 2006/0265555 A1
(43) Pub. Date: Nov. 23, 2006

(54) Methods and apparatus for sharing processor resources

(75) Inventors: Gordon T. Davis, Chapel Hill, NC (US); Jeffrey H. Derby, Chapel Hill, NC (US)

Correspondence Address: IBM Corporation;Intellectual Property Law Dept. 917, 3605 Hwy. 52 North, Rochester, MN, 55901, US

(73) Assignee: International Business Machines Corporation, Armonk, NY (US)

(21) Appl. No.: 11/132,656

(22) Filed: May 19, 2005

(51) Int. Cl. G06F 13/28

(52) U.S. Cl. 711/147

(57) ABSTRACT

In a first aspect, a first method is provided for sharing processor resources. The first method includes the steps of (1) grouping a plurality of physical registers into at least one array, wherein registers in each of the at least one array share read and write ports and wherein at least two types of execution units are coupled to each of the at least one array; and (2) storing different types of data at different times in at least one of the registers from the at least one array, wherein each of the different types of data is associated with at least a different one of the execution units. Numerous other aspects are provided.

### CROSS REFERENCE TO RELATED APPLICATION

The present application is related to U.S. patent application Ser. No. ______, filed on even date herewith and titled “METHODS AND APPARATUS FOR DYNAMICALLY SWITCHING PROCESSOR MODE” (Attorney Docket No. ROC920040358), which is hereby incorporated by reference herein in its entirety.

### FIELD OF THE INVENTION

The present invention relates generally to processors, and more particularly to methods and apparatus for sharing processor resources.

### BACKGROUND

In conventional processors, different types of execution units may have dedicated registers and may operate independently. For example, integer execution units (FXUs) are typically coupled to a group of dedicated general purpose registers (GPRs), floating point execution units (FPUs) are typically coupled to a group of dedicated floating point registers (FPRs), vector execution units (VMXs) are typically coupled to a group of dedicated vector registers (VPRs), and so on.

Each set of dedicated registers includes respective read and write ports. Further, each group of dedicated registers generally is sized to accommodate a worst-case scenario. Therefore, during normal operation, many registers in each group of dedicated registers may remain unused depending on the application executed by the processor.

By requiring read and write ports corresponding to each group of dedicated registers, sizing each group of dedicated registers for a worst case scenario and/or employing execution units which are independent of each other, conventional processors use silicon area and consume power inefficiently.

### SUMMARY OF THE INVENTION

In a first aspect of the invention, a first method is provided for sharing processor resources. The first method includes the steps of (1) grouping a plurality of physical registers into at least one array, wherein registers in each of the at least one array share read and write ports and wherein at least two types of execution units are coupled to each of the at least one array; and (2) storing different types of data at different times in at least one of the registers from the at least one array, wherein each of the different types of data is associated with at least a different one of the execution units.

In a second aspect of the invention, a second method is provided for sharing processor resources. The second method includes the steps of (1) grouping a plurality of physical registers into a first array and second array, wherein registers in the first array share read and write ports, registers in the second array share read and write ports, and each of the first and second arrays are coupled to one or more portions of different types of execution units; (2) allowing a register from the first array to store different types of data at different times; and (3) allowing a register from the second array to store different types of data at different times.

In a third aspect of the invention, a processor is provided. The processor includes (1) a plurality of physical registers grouped into at least one array, wherein registers in each of the at least one array share read and write ports; and (2) at least two types of execution units coupled to each of the at least one array. The processor is adapted to store different types of data at different times in at least one of the registers from the at least one array, wherein each of the different types of data is associated with at least a different one of the execution units.

In a fourth aspect of the invention, a system is provided for sharing processor resources. The system includes (1) memory; (2) a storage device; and (3) a processor, coupled to memory and storage device, having (a) a plurality of physical registers grouped into at least one array, wherein registers in each of the at least one array share read and write ports; and (b) at least two types of execution units coupled to each of the at least one array. The processor is adapted to store different types of data at different times in at least one of the registers from the at least one array, wherein each of the different types of data is associated with at least a different one of the execution units. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE FIGURES

FIG. 1 is a block diagram of a system including a first exemplary processor in accordance with an embodiment of the present invention.

FIG. 2 is a block diagram of a queue of available registers employed by a processor while operating in a mode that does not support simultaneous operations on a plurality of threads in accordance with an embodiment of the present invention.

FIG. 3 is a block diagram of queues of available registers employed by a processor while operating in a mode that supports simultaneous operations on a plurality of threads in accordance with an embodiment of the present invention.

FIG. 4 is a block diagram of a second exemplary processor in accordance with an embodiment of the present invention.

FIG. 5 illustrates a method of sharing processor resources in accordance with an embodiment of the present invention.

### DETAILED DESCRIPTION

The present invention provides methods and apparatus for sharing processor resources, such as registers, so that a silicon area required by the processor and/or power consumed by the processor are reduced. More specifically, the present invention replaces the dedicated registers of conventional processors with a unified register stack, which may include a plurality of registers (e.g., GPRs (General Purpose Registers such as Integer Registers), FPRs (Floating Point Registers), and/or VPRs (Vector Processor Registers)) grouped together in one or more arrays. Each array includes respective read and write ports. In contrast to conventional processors, different types of execution units may be coupled to the unified register stack, thereby sharing the registers and the read and/or write ports of such registers which reduces the silicon area required by the processor and power consumed thereby. Therefore, a register from the unified register stack may be allocated to store integer, floating point or vector data. In one embodiment, one or more queues of available registers from the unified register stack may be formed. When a register is required to store, for example, integer, floating point or vector data, the processor may allocate a register from the start of one of the queues to store such data. The processor may employ register renaming to map a physical address of such a register to an architected register address. Once such a register is no longer required to store the data, the architected register address may be unassigned from the register and the register may be placed at the end of the queue. Thereafter, that register may be employed to store any type of data (e.g., a different type of data).

By allowing registers in the unified register stack to store different types of data at different times, all registers in the unified register stack may be available to store integer, floating point or vector data. Therefore, for example, if a worst case scenario (e.g., an operation that required all the registers in the unified register stack) occurred for both the integer and floating point execution units at the same time, unused registers which may previously have been used to store vectors may be allocated to store integer data and/or floating point data as required. Because the worst case scenario for all types of execution units is unlikely to occur simultaneously, the total number of registers included in the unified register stack does not have to account for the worst case scenario for all types of execution units. Consequently, compared to conventional processors, the overall number of registers required by the processor may be reduced. Further, because the different execution units may share read and/or write ports, an overall number of such ports may be reduced. In this manner, silicon area required by the processor and power consumed thereby is reduced. Additionally or alternatively, the execution units coupled to the one or more register arrays may also share logic, further reducing silicon area required by the processor and power consumed by the processor.

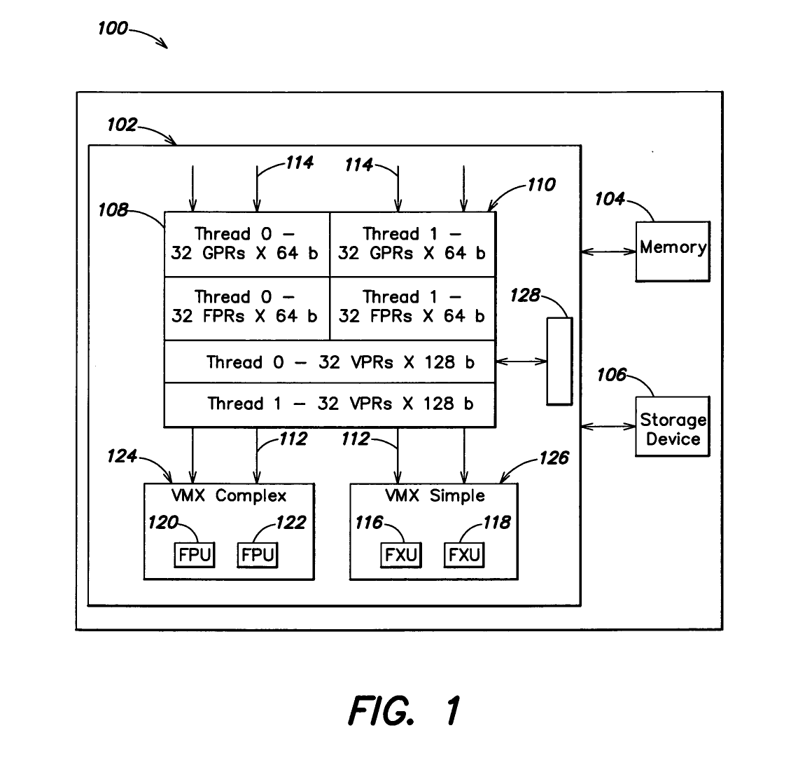

FIG. 1 is a block diagram of a system including a first exemplary processor in accordance with an embodiment of the present invention. With reference to FIG. 1, the system 100 may be a personal computer, server, or the like and may include the first exemplary processor 102 coupled to a memory 104 for storing data and/or a storage device 106 such as a hard disk drive or similar device. The first exemplary processor 102 may include a plurality of physical registers 108 (e.g., GPRs, FPRs, and/or VPRs) grouped into one or more arrays 110 (only one shown). The registers 108 in each of the one or more arrays 110 may share read and/or write ports 112, 114. A plurality of types of execution units may be coupled to each of the one or more arrays 110. For example, two or more of an integer execution unit (FXU) 116-118, floating point unit (FPU) 120-122 and/or vector execution unit (VMX) 124-126 may be coupled to ports 112, 114 of each of the one or more arrays 110. Although the processor 102 includes two FXUs 116-118, two FPUs 120-122 and two VMXs 124-126, a larger or smaller number of FXUs, FPUs and/or VMXs may be employed. In this manner, the plurality of physical registers 108 grouped into one or more arrays 110 may serve as a unified register stack. The unified register stack may create a natural path for moving data between GPRs, FPRs and/or VPRs. Further, special paths may not be required for moving data between execution units, and therefore, movement of data between different execution units may be facilitated.

The FXUs 116-118, FPUs 120-122 and/or VMXs 124-126 may include any suitable combination of logic, registers, memory or the like, and in at least one embodiment may comprise or be part of an application specific integrated circuit (ASIC). In some embodiments, two or more execution units 116-126 may share logic. For example, a vector execution unit 124 adapted to perform complex calculations may share logic with one or more FPUs 120-122, and a vector execution unit 126 adapted to perform simple calculations may share logic with one or more FXUs 116-118 (although execution unit logic may be shared differently). By sharing logic between two or among more execution units 116-126, the first exemplary processor 102 may require less logic overall, thereby reducing power consumed by the processor 102 and/or silicon area required thereby.

Additionally or alternatively, the registers 108 in each of the one or more arrays 110 may share read ports 112 and/or write ports 114. By sharing read ports 112 and/or write ports 114 among the registers 108 of each of the arrays 110, an overall number of read ports 112 and/or write ports 114 required by the first exemplary processor 102 may be reduced. Consequently, an overall amount of logic required for such read ports 112 and write ports 114 may be reduced, thereby reducing power consumed by the processor 102 and/or silicon area required thereby.

Registers 108 included in an array 110 may be of one or more sizes. For example, the registers 108 may be 64 bits or 128 bits wide (although different register sizes may be employed). Further, the processor 102 may be adapted to operate in a first mode that supports simultaneous operations on a plurality of threads (e.g., two threads) or in a second mode that does not support such operations. The processor's mode of operation may be based on a parameter provided during configuration. In this manner, the array 110 may include thirty-two 64-bit registers (e.g., general purpose registers (GPRs)) that store integer data, thirty-two 64-bit registers (e.g.,. floating point registers (FPRs) that store floating point data and thirty-two 128-bit registers (e.g., VPRs) that store vector data corresponding to a first thread. Similarly, the array 110 may include thirty-two 64-bit registers (e.g., GPRs) that store integer data, thirty-two 64-bit registers (e.g., FPRs) that store floating point data and thirty-two 128-bit registers (e.g., VPRs) that store vector data corresponding to a second thread.

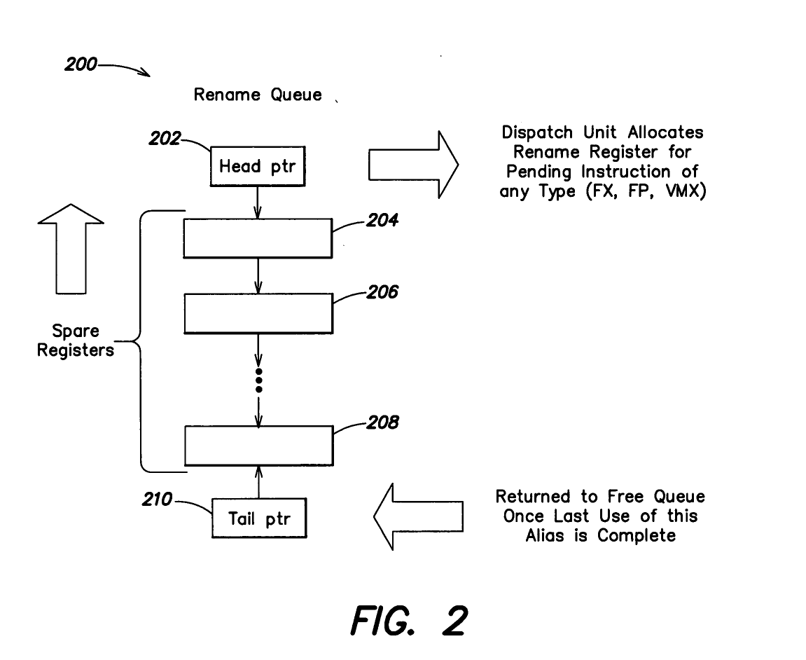

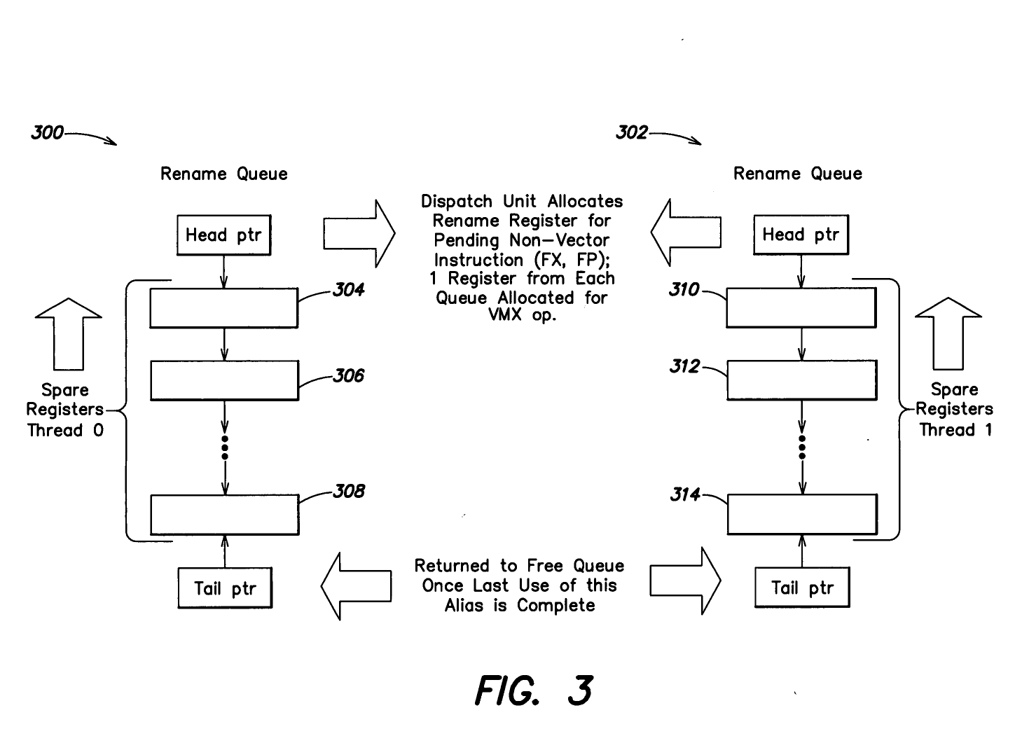

However, the registers 108 in the array 110 may be employed to store data in a different manner as required. For example, a larger or smaller number of registers (e.g., GPRs, FPRs and/or VPRs) may be employed to store integer data, floating point data and/or vector data. More specifically, registers 108 previously used to one type of data may be used (e.g., allocated) later to store another type of data. The processor 102 may include logic, such as dispatch logic 128, adapted to allocate registers as required. Allocation of registers 108 in the one or more arrays 110 by the processor 102 while operating in the mode that supports simultaneous operations on two threads and while operating in the mode that does not support such operations are described below with reference to FIGS. 2 and 3, respectively.

By sharing resources in this manner, the processor 102 provides increased flexibility compared to conventional processors. For example, allocation of registers may be adjusted dynamically according to application requirements. More specifically, as stated, because a register 108 in the array 110 may be employed to store a different type of data at different times, if a worst case scenario occurred for both the integer and floating point execution units at the same time such that all the registers in the unified register stack are required to store such data, unused registers which may previously have been used to store vectors may be allocated to store the integer data and/or floating point data as required. Because the worst case scenario for all execution units is unlikely to occur simultaneously, the total number of registers included in the array 110 does not have to account for the worst case scenario for all three types of data. Consequently, compared to conventional processors, the overall number of registers 108 required by the processor 102 may be reduced, thereby reducing power consumed by the processor 102 and/or silicon area required thereby.

During operation, the one or more arrays 110 may include a number or pool of registers 108 that are available to store any type of data (e.g., integer data, floating point data or vectors). A register 108 may be available to store data if the register is not currently storing data. In some embodiments, all registers (e.g., GPRs, FPRs and VPRs) may initially be in the pool of available registers. The processor 102 may manage the pool of available registers such that the dispatch logic 128 may allocate an available register to store any type of data as required. In this manner, such pool of available registers may be shared among all types of execution units. More specifically, FIG. 2 is a block diagram of a queue of available registers employed by the processor 102 while operating in a mode that does not support simultaneous operations on a plurality of threads in accordance with an embodiment of the present invention. With reference to FIG. 2, while operating in a mode that does not support simultaneous operations on a plurality of threads, the processor 102 may arrange the pool of available (or spare) registers 108 into a queue 200. The queue 200 may include a head pointer 202 that points to a next available register 204 in the queue 200 of available registers. A portion of the next available register 204 may store a pointer to the available register 206 following the next available register 204 in the queue 200. In a similar manner, a portion of register 206 may store a pointer to a subsequent register (not shown) in the queue 200, and so on, until the last register 208 in the queue is reached. The queue 200 may include a tail pointer that points to the last available register 208 in the queue 200 of available registers.

The dispatch unit 128 may remove an available register (which may be any type of register, such as a GPR, FPR or VPR) from the queue 200 and allocate such register for a pending instruction. For example, the dispatch unit 128 may remove the first register 204 from the queue 200 and allocate such register for a pending instruction. As the first register 204 is removed from the queue 200, the head pointer 202 may be updated to point to the next register 206 in the queue 200. The head pointer 202 is updated with the pointer that was in register 204 (e.g., pointing to register 206). In this manner, such next register 206 becomes the first register in the queue 200. While allocating a register for a pending instruction (or after data corresponding to the pending instruction has been stored in the register), the processor 102 may employ (e.g., dynamically) register renaming, in which the address of the physical register is mapped to an architected (or programmable-addressable) register address. The physical register address may represent a hardware address of the register and the architected register address may represent an address that is known by a computer program writer and/or compiler software, and therefore, such address may be encoded in instructions executed by the processor 102. Therefore, available registers 204-208 in the queue 200 may serve as registers that may be renamed (e.g., rename registers), and consequently, the queue 200 serves as a rename queue.

Further, when a register previously allocated to store data is no longer required to store data, such register may be placed on the queue 200 of available registers. More specifically, the mapping of the physical register address to an architected address may be removed and the register may be placed on the queue 200. For example, such register may be placed on the end of the queue 200. A pointer in the previously-last register in the queue 200 may be stored to point to the register (e.g., 208) added to the queue 200. Further, the tail pointer 202 may be updated to point to the register (e.g., 208) added to the end of the queue 200.

In this manner, while the processor 102 operates on a single thread, the physical registers 108 in the one or more arrays 110 may be allocated from the queue 200 as required to store different types of data (e.g., integer data, floating point data or vectors) at different times. Although registers 204-208 are allocated (e.g., removed) from a start of the queue 200 and placed to the end of the queue 200, in some embodiments, registers may be allocated and/or placed on the queue 200 in a different manner. Further, although the processor 102 organizes available registers 108 in the array 110 into a queue 200 or linked list, the processor 102 may organize the register 108 using a different type of structure.

In this manner, the processor 102 may manage the pool of available registers. In some embodiments, most or all available registers (e.g., GPRs, FPRs and/or VPRs) are initially placed in the queue 200 of rename registers. Different execution unit types (e.g., FXUs 116-118, FPUs 120-122 and/or VMXs 124-126) may request a register from the queue, and in response, the processor 102 may allocate registers from the queue as required.

As an instruction of any type completes, the working target register is declared the current architected register. If some other physical register was previously allocated as the same architected register, such physical register may be returned to the queue 200 of rename registers. In contrast to conventional processors in which each execution unit type requests and receives registers from an independent queue of available registers for that type of execution unit, the present invention may allow different types of execution units to share registers (e.g., GPRS, FPRs and/or VPRs) from a common pool (e.g., the queue 200). Thus, during a first time, a specific physical register might be renamed as a GPR and allocated to store integer data. However, during a second time subsequent to the first time, that physical register might be renamed as an FPR and allocated to store floating point data. In this manner, usage efficiency of processor resources, such as available registers, may be increased and/or optimized such that operations may not be limited by lack of available registers.

In contrast, FIG. 3 is a block diagram of queues of available registers employed by the processor while operating in a mode that supports simultaneous operations on a plurality of threads in accordance with an embodiment of the present invention. With reference to FIG. 3, while operating in a mode that supports simultaneous operations on a plurality of threads, the processor 102 may arrange the pool of available (or spare) registers 108 into a first and second queues 300, 302 of available registers. The general structure and operation of each of the first and second queues 300, 302 is similar to the queue 200 of FIG. 2, and therefore, are not described again in detail herein. The processor 102 may allocate registers 304-308 from the first queue 300 for instructions corresponding to a first thread. More specifically, the dispatch unit 128 may remove an available register (e.g., register 304) from the first queue 300 and allocate such register for a pending integer or floating point (e.g., non-vector) instruction. Similarly, the processor 102 may allocate registers 310-314 from the second queue 302 for instructions corresponding to a second thread (e.g., assuming the processor 102 is operating on two threads simultaneously). More specifically, the dispatch unit 128 may remove an available register (e.g., register 310) from the second queue 302 and allocate such register for a pending integer or floating point (e.g., non-vector) instruction. As shown in FIG. 2, while operating in the mode that does not support simultaneous operations on a plurality of threads, a register for a pending vector instruction may be allocated from the queue 200. However, in contrast, while operating in a mode that does support simultaneous operations on a plurality of threads, the processor 102 allocates a register 304-308, 310-314 from each of the first and second queues 300, 302 for a vector instruction.

Although the processor 102 is operating in a mode that supports simultaneous operations on a plurality of threads, at times, the processor 102 may still operate on a single thread. During such times, the processor 102 may allocate registers 304-308 for a pending integer or floating point (e.g., non-vector) instruction from the first queue 300 and registers 304-308, 310-314 for a pending vector instruction from the first and second queues 300, 302.

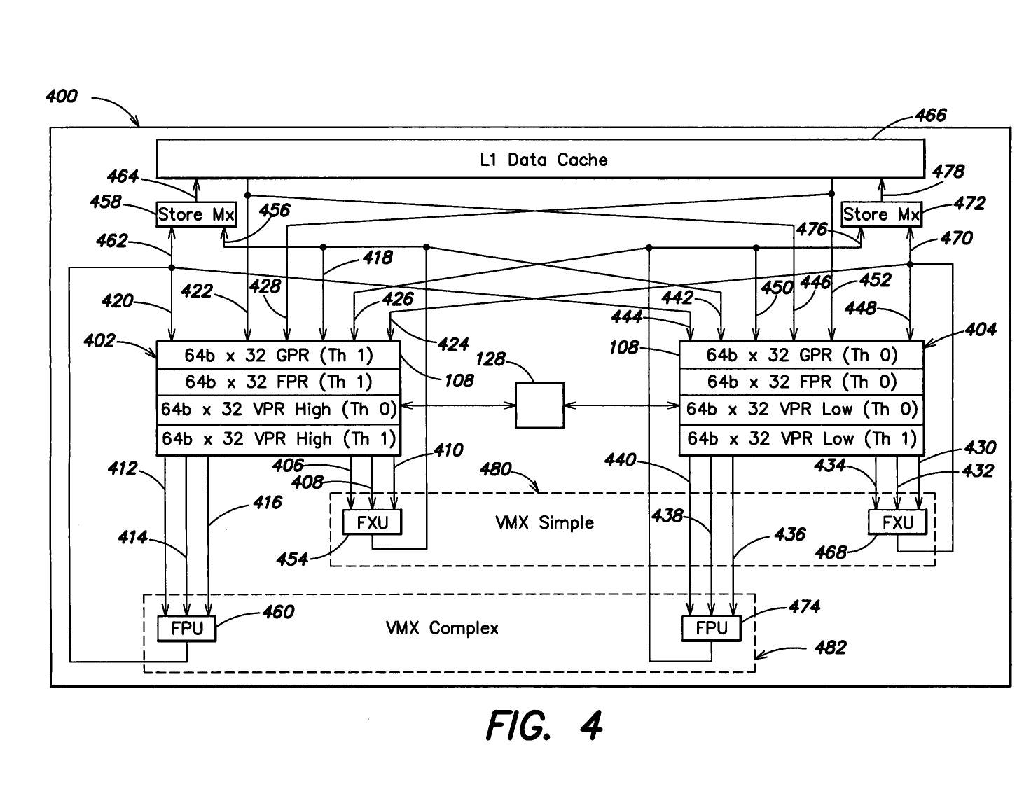

Although, the first exemplary processor 102 includes a plurality of physical registers 108 grouped into an array 110, in some embodiments, the plurality of registers 108 may be grouped into a plurality of arrays. FIG. 4 is a block diagram of a second exemplary processor in accordance with an embodiment of the present invention. For example, with reference to FIG. 4, the second processor 400 may include a first array 402 for storing a first portion of a plurality of registers 108 and a second array 404 for storing a second portion of the plurality of registers 108. Registers 108 of the first array 402 may share read and/or write ports. In some embodiments, registers 108 of the first array 402 share six read ports 406-416 and six write ports 418-428 (although a larger or smaller number of read and/or write ports may be employed). Similarly, registers 108 of the second array 404 may share read and/or write ports. In some embodiments, registers 108 of the second array 404 share six read ports 430-440 and six write ports 442-452 (although a larger or smaller number of read and/or write ports may be employed).

The first and second arrays 402-404 may be coupled to dispatch logic 128. Further, each of the first and second arrays 402, 404 may be coupled to one or more portions of different types of execution units. Further, logic, such as arithmetic logic units (ALUs) and hardware multipliers, may be shared among the different types of execution units. For example, the first array 402 may be coupled to a first FXU 454 via some read ports (e.g., a first through third read port 406-410) shared by registers 108 of the first array 406. An output of the first FXU 454 may be coupled to a first write port 418 of the first array 402 and a first write port 442 of the second array 404. Furthers the output of the first FXU 454 may be coupled to a first input 456 of a first store multiplexer 458.

Similarly, the first array 402 may be coupled to a first FPU 460 via some read ports (e.g., a fourth through sixth read port 412-416) shared by registers 108 of the first array 406. An output of the first FPU 460 may be coupled to a second write port 420 of the first array 402 and a second write port 444 of the second array 404. Further, the output of the first FPU 460 may be coupled to a second input 462 of the first store multiplexer 458. An output 464 of the first store multiplexer 458 may be coupled to a cache memory 466 (e.g., L1 Data Cache of the processor 400). The first store multiplexer 458 is adapted to selectively output data received by the first or second inputs 456, 462 to the cache memory 466. A first output of the cache memory 466 may be coupled to a third write port 422 of the first array 402 and a third write port 446 of the second array 404.

The second array 404 may be coupled to a second FXU 468 via some read ports (e.g., a first through third read port 430-434) shared by registers 108 of the second array 404. An output of the second FXU 468 may be coupled to a fourth write port 448 of the second array 404 and a fourth write port 424 of the first array 402. Further, the output of the second FXU 468 may be coupled to a first input 470 of a second store multiplexer 472.

Similarly, the second array 404 may be coupled to a second FPU 474 via some read ports (e.g., a fourth through sixth read port 436-440) shared by registers 108 of the second array 404. An output of the second FPU 474 may be coupled to a fifth write port 450 of the second array 404 and a fifth write port 426 of the first array 402. Further, the output of the second FPU 474 may be coupled to a second input 476 of the second store multiplexer 472. An output 478 of the second store multiplexer 472 may be coupled to the cache memory 466. The second store multiplexer 472 is adapted to selectively output data received by the first or second inputs 470, 476 to the cache memory 466. A second output of the cache memory 466 may be coupled to a sixth write port 452 of the second array 404 and a sixth write port 428 of the first array 402.

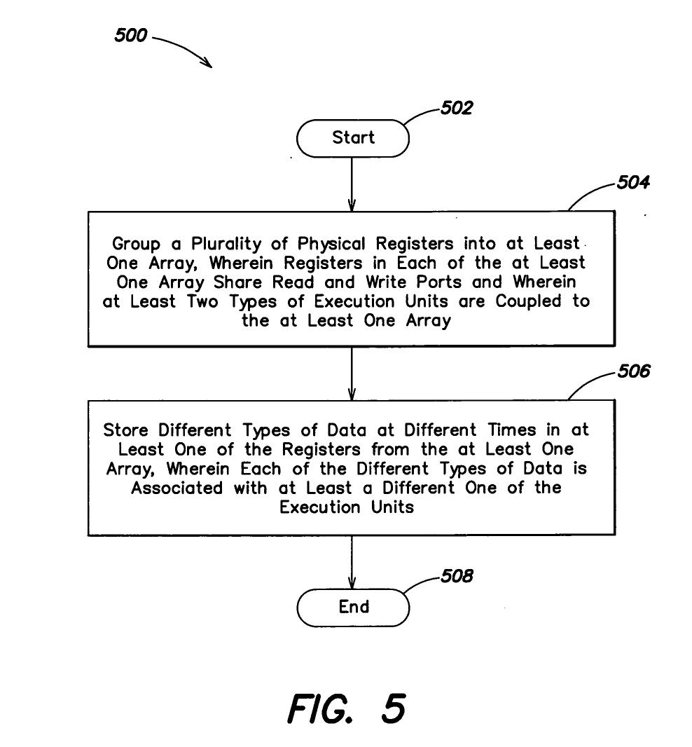

Duplicating data input to GPRs and/or FPRs of the first array 402 via write ports (e.g., the first through third write ports 418-422) to GPRs and/or FPRs of the second array 404 via write ports (e.g., the first through third write ports 442-446) and/or duplicating data input to GPRs and/or FPRs of the second array 404 via write ports (e.g., the fourth through sixth write ports 448-452) to GPRs and/or FPRs of the first array 402 via write ports (e.g., the fourth through sixth write ports 424-428) may enable more efficient use of the execution units of the processor 400. Such efficient use is described below with reference to FIG. 5.

Further, the second exemplary processor 400 may include a first VMX 480 (e.g., a VMX for performing simple operations) coupled to some read ports (e.g., the first through third read ports 406-410) of the first array 402 and some read ports (e.g., the first through third read ports 430-434) of the second array 404. As shown the first VMX 480 may share logic with the first and/or second FXUs 454, 468. For example, the first VMX 480 may include the first and/or second FXUs 454, 468.

Additionally, the second exemplary processor 400 may include a second VMX 482 (e.g., a VMX for performing complex operations) coupled to some read ports (e.g., the fourth through sixth read ports 412-416) of the first array 402 and some read ports (e.g., the fourth through sixth read ports 436-440) of the second array 404. As shown the second VMX 482 may share logic with the first and/or second FPUs 460, 474. For example, the second VMX 482 may include the first and/or second FPUs 460, 474.

By sharing read and/or write ports 406-416, 418-428 among registers 108 of the first array 402, and by sharing read and/or write ports 430-440, 442-452 among registers 108 of the second array 404, the processor 400 may require a smaller number of read and/or write ports overall, thereby requiring less logic overall. Consequently, power consumed by the processor 400 and/or silicon area required thereby may be reduced. Additionally or alternatively, by sharing logic between (or among) the different types of execution units, the processor 400 may require less logic overall, thereby reducing power consumed by the processor 400 and/or silicon area required thereby.

Although details of the interconnectivity of the components of the second exemplary processor 400, which includes registers grouped into a plurality of arrays, are described above, it should be understood that components of the first exemplary processor 102 may be connected in a similar manner.

The operation of an apparatus for sharing processor resources is now described with reference to FIGS. 1-4, and with reference to FIG. 5 which illustrates a method of sharing processor resources in accordance with an embodiment of the present invention. With reference to FIG. 5, in step 502, the method 500 begins. In step 504, a plurality of physical registers are grouped into at least one array, wherein registers in each of the at least one array share read and write ports and wherein at least two types of execution units are coupled to the at least one array. More specifically, a plurality of physical registers 108 may be grouped together as shown in the array 110 of the first processor 102. In this manner, the physical registers 108 in the array 110 may share the read and/or write ports 112, 114 and couple to two or more types of execution units, such as an integer execution unit (FXU) 116-118, floating point execution unit (FPU) 120-122 and vector execution unit (VMX) 124-126, using such ports 112, 114. As described above, in some embodiments, logic may be shared between two or more types of the execution units 116-126.

The grouping of the plurality of registers 108 included in the first exemplary processor 102 into the array 110 is exemplary, and therefore, different configurations may be employed to achieve the above-described advantages. For example, in some embodiments, a plurality of physical registers 108 may be grouped into more than one array. More specifically, the physical registers 108 may be grouped into a first array 402 and second array 404, wherein registers 108 in the first array 402 share read and write ports, registers in the second array 404 share read and write ports, and each of the first and second arrays 402, 404 are coupled to one or more portions of different types of execution units. More specifically, the plurality of physical registers may be grouped together as shown in the first and second arrays 402, 404 of FIG. 4. In this manner, physical registers 108 in the first array 402 may share the read and/or write ports 406-416, 418-428 coupled to the first array 402, and couple to one or more portions of different types of execution units such as an FXU 454, an FPU 460 and VMXs 480, 482. Similarly, physical registers 108 in the second array 404 may share the read and/or write ports 430-440, 442-452 coupled to the second array 404, and couple to one or more portions of different types of execution units such as an FXU 468, an FPU 474 and VMXs 480, 482.

In step 506, different types of data are stored at different times in at least one of the registers from the at least one array, wherein each of the different types of data is associated with at least a different one of the execution units. As described above, depending on the mode of operation, the processor 102 may form one or more queues of available registers from which to allocate registers for instructions as required. For example, while operating in a first mode that does not support simultaneous operations on a plurality of threads, the processor 102 may form a single queue 200 from which a register may be allocated. In this manner, the processor 102 (e.g., the dispatch logic 128 of the processor 102) may allocate (e.g., dynamically) a physical register 108 from the queue 200 and map the address of the physical register 108 to an architected register address as required. In this manner, for example, during a first time, the processor 102 may allocate a first physical register 108 from the queue 200 to store one of integer data, floating point data and vectors and may store such data in the allocated register. Alternatively, in some embodiments, mapping to an architected register address may occur after data is stored in the allocated register.

Once the data stored in such register 108 is no longer required to be stored, the processor 102 may remove the mapping of the physical register address to the architected register address. Thereafter, the processor 102 may place such physical register 108 (e.g., a newly-available physical register) on the queue 200 of available registers 108. For example, the processor 102 may place the newly-available physical register 108 on the end of the queue 200 such that other physical registers are before the newly-available physical register. After the other physical registers before the newly-available register are allocated from the queue 200 to store data, during a second time (e.g., different than the first time), the processor 102 may allocate the newly-available physical register again to store data. In contrast to the first time in which the processor 102 allocated the register 108 to store one of integer data, floating point data and vectors, during the second time, the processor 102 may allocate the register 108 to store a remaining one of integer data, floating point data and vectors. In this manner, such physical register 108 may be used to store different types of data at different times. As described above, the flexibility of using a physical register 108 to store different types of data at different times enables a processor 102 to reduce an overall number of registers required to store the different types of data.

Alternatively, while operating in a second mode that supports simultaneous operations on a plurality of (e.g., two) threads, the processor 102 may form a first queue 300 from which a register may be allocated for instruction corresponding to a first thread (e.g., thread 0) and a second queue 302 from which a register may be allocated for an instruction corresponding to a second thread (e.g., thread 1). To support simultaneous operations on two threads, registers may be allocated for integer or floating point instructions from each respective queue 300, 302 in the manner similar to that described above for the queue 200 formed by the processor 102 while operating in a mode that does not support simultaneous operations on a plurality of threads. However, in contrast to the first mode, while the processor 102 operates in the second mode to allocate a register for a vector instruction, which may require a larger-sized register, the processor 102 may allocate a register from each of the first and second queues 300, 302 to accommodate such requirement. In this manner, the processor 102 may allocate a first register from the first queue 300 as required by the first thread and may allocate a first register from the second queue 302 as required by the second thread. As described above, the processor 400 may share logic between execution units. Therefore, the vector instruction may require the first and second FXUs 454, 468 to complete a simple vector operation, or the first and second FPUs 460, 474 to complete a complex vector operation. Consequently, each FXU 454, 468 and/or FPU 460, 474 may need to partition computation in to smaller slices to support operations on individual vector elements. Computation may be partitioned by breaking the carry propagation within each execution unit. Further, in some embodiments, a permute unit (not shown) adapted to reorder vector elements may be coupled to the same ports as an FXU 454, 468, and thereby, share such ports with the FXU 454, 468.

When registers allocated from the first and/or second queues 300, 302 are no longer required to store such data, the allocated registers may be returned to their respective queues 300, 302. Thereafter, such registers may be allocated to store data of a respective type different than that previously-stored by such registers.

Alternatively, although the processor 102 is operating in the second mode, the processor 102 may operate on a single thread. While operating on the single thread, for example, the processor 102 may allocate registers from the first queue 300 for integer or floating point instructions in a manner similar to that described above for the queue 200 formed by the processor 102 while operating in a mode that does not support simultaneous operations on a plurality of threads. However, in contrast, while operating on a single thread in the second mode, data written to a register allocated from the first queue may be written to (e.g., duplicated in) a register allocated from the second queue, and vice versa. As described above, the write ports 114 of registers in the array 110, some registers of which are included in the first queue 300 and some registers of which are included in the second queue 302, may be shared, and therefore, data written to a register allocated from the first queue 300 may be duplicated in a register allocated from the second queue 302. More specifically, in such mode, the two register arrays may have duplicate contents. The processor 102, 400 may allocate registers in pairs (e.g. when GPR n is allocated, that register is allocated in both arrays). In this manner, while operating on a single thread in the second mode, additional register ports 112, 114 are made available to the thread, and therefore, an execution unit 116-126 coupled to registers in either the first or second arrays 402, 404 may be employed to support an instruction from a single-threaded application, thereby efficiently employing execution units 116-126 of the processor 102. Thus what would appear as a dual-issue per thread apparatus when the processor 400 simultaneously operates on two threads while in the second mode, becomes a four-issue apparatus when the processor 400 operates on a single thread while in the second mode. In this manner, the processor 400 may efficiently employ logic such that single-threaded and multi-threaded applications may increase and/or maximize processor resource usage.

While operating on a single thread in the second mode, when registers allocated from the first and/or second queues 300, 302 are no longer required to store such data, the allocated registers may be returned to their respective queues 300, 302. Thereafter, such registers may be allocated to store data of a respective type different than that previously-stored by such registers.

Thereafter, step 508 is performed. In step 508, the method 500 ends. Although the method 500 is described above with reference to the first exemplary processor 102 in which a plurality of registers are shown grouped into an array 110, it should be understood that the present method may be employed by a processor in which physical registers are grouped into more than one array, such as the second exemplary processor 400 of FIG. 4.

In either case, the processors 102, 400 may operate in the first or second mode described above and form one or more queues of available physical registers in the manner described above. For example, the first array 402 of the second exemplary processor 400 may be employed to support a first thread (e.g., thread 0) and the second array 404 of the second exemplary processor 400 may be employed to support a second thread (e.g., thread 1). This may lead to an affinity of one FXU and one FPU to each thread. For example, the first FXU 454 and first FPU 460 may generally operate on instructions corresponding to the first thread, and the second FXU 468 and second FPU 474 may generally operate on instructions corresponding to the second thread. In this manner, the first and second register arrays 402, 404 may have different contents. Available registers from each array 402, 404 may be independently allocated to respective supported threads as required. However, for vector instructions, the processor 400 may access the first and second register arrays 402, 404 in tandem to support the register width required by a vector instruction (e.g., 128 bits). Additional registers in each array may support the second thread. More specifically, a request for an available register for a vector operation may be presented to the first and second queues 300, 302. The same physical register from each array does not have to be allocated, as long as the chosen physical register from each array is mapped to the appropriate architected register. Subsequent access to the VPR formed by such chosen registers may then require independent address control for the two register arrays.

Through use of the method 500, a processor 102, 400 may share resources thereby reducing power consumed by the processor 102, 400 and/or silicon area required thereby. More specifically, the present methods and apparatus may maximize reuse of hardware of various resources such that overall logic required by the processor is reduced. For example, an overall number of registers, read and/or write ports and/or execution unit logic required by the processor may be reduced. The present methods and apparatus may be employed by a server thereby improving commercial applications and/or a personal computer thereby improving consumer applications.

The foregoing description discloses only exemplary embodiments of the invention. Modifications of the above disclosed apparatus and methods which fall within the scope of the invention will be readily apparent to those of ordinary skill in the art. For instance, in some embodiments, any of the FXUs 454, 468 or FPUs 460, 474 may be reused to support load and store operations if not required to support computation operations. In this manner, the number of read ports 406-416, 430-440 required by a register array 402, 404 may be reduced. Further, the processor 400 may efficiently employ logic by reusing arithmetic building blocks for address computations. Further, in some embodiments, a number of registers included in the unified register stack may be adjusted to support extra registers for renaming of various architected registers.

The present methods and apparatus facilitate register renaming because registers (e.g., GPRs, FPRs and VPRs) share a common array. For example, if a particular execution unit type is not being used, all registers for that execution unit type may be made available for use by active execution units using register renaming. Thus, for applications that may not be vectorized, VPRs may be made available for execution units performing integer and/or floating point operations using register renaming. For applications requiring purely integer operations, FPRs may be made available for execution units performing integer and/or vector operations. For applications requiring some use (but not heavy use) of a register type, unused registers of that type may be reallocated as renaming registers (e.g., may be made available for use as different types of registers). Further, for single-threaded applications, VPR registers allocated to the second thread may be reallocated (if unused) using register renaming.

Further in some embodiments, the processor may include GPRs representing 32 registers×8 bytes×2 threads=512 bytes; FPRs representing 32 registers×8 bytes×2 threads=512 bytes; and VPRs representing 32 registers×16 bytes×2 threads=1024 bytes. Therefore, a total of 2048 bytes, which may be partitioned into 2×64 bit slices, may be included in a single array. Such array may include a total of twelve read ports and/or twelve write ports. In the second mode, each thread may have affinity to one FXU and one FPU, thereby avoiding requiring another 1024 bytes. Further, while operating on a single thread in the second mode, contents stored in GPRs and/or FPRs corresponding to a first thread may be duplicated in GPRs and/or FPRs corresponding to a second thread. Unused registers previously employed to store a first type of data may be allocated to store a second type or data using register renaming. In this manner, thirty-two registers per thread for renaming may be available for pure integer apps. It should be noted the VMX unit may require register pairs. Further, thirty-two registers for renaming may be available for single-threaded applications, sixty-four registers may be available for pure integer applications, and sixty-four registers per thread for renaming may be available for applications that do not use a VMX.

While operating on simultaneous threads, a processor of the present methods and apparatus may operate on one floating point operation, one integer operation and one branch operation per thread per cycle. A load or store operation may be substituted for the floating point and/or integer operation. The processor may perform a maximum of one store operation per thread and a maximum of two total load operations across both threads. While operating on a single thread, a processor of the present methods and apparatus may operate on two floating point operations, two integer operations and one branch operation per cycle. A load store operation may be substituted for the floating point and/or integers operations. The processor may perform a maximum of two load and two store operations. Although the design of a processor included in some embodiments is described above, in other embodiments, the processor may be configured differently. For example, one or more of the parameters described above may be different.

As described above, in some embodiments, the processor may include a first vector execution unit 480 that may perform a simple or permute instruction using a first and second integer execution unit 454, 468. The processor may include a second vector execution unit 482 that may perform a complex instruction using a first and second floating point unit 460, 474. A load and store operation may be performed by the first and/or second execution unit 454, 468.

In this manner, the present methods and apparatus may provide advantages (e.g., compared to conventional processor) such as a significant reduction in silicon area required and power consumed, a consolidation of register resources into one or more arrays, thereby minimizing a total number of read and write ports required, and/or employing register renaming without requiring additional registers. Further, the present methods and apparatus may improve and/or maximize utilization of resources by allowing register that are not used by a first execution unit to be reallocated as rename registers for a second more active execution unit, reallocating registers allocated to an idle thread as rename registers for an active thread. In this manner, a global pool of rename registers may be distributed according to workload demand among multiple execution units. Thus, register renaming may be enabled without requiring additional resources and rename registers may be applied where needed, resulting in more available registers applied to critical code. The present methods and apparatus may support vector applications without imposing a significant penalty on applications that may not use vectors and may support multi-threaded applications without imposing a penalty on applications that are not multi-threaded.

Accordingly, while the present invention has been disclosed in connection with exemplary embodiments thereof, it should be understood that other embodiments may fall within the spirit and scope of the invention, as defined by the following claims.

The invention claimed is:

1. A method of sharing processor resources, comprising:
grouping a plurality of physical registers into at least one array, wherein registers in each of the at least one array share read and write ports and wherein at least two types of execution units are coupled to each of the at least one array; and
storing different types of data at different times in at least one of the registers from the at least one array, wherein each of the different types of data is associated with at least a different one of the execution units.

2. The method of claim 1 wherein storing different types of data at different times in at least one of the registers from the at least one array includes:
forming at least one queue of available physical registers from the at least one array; and
during a first time, allocating a first physical register from one of the at least one queue of available registers to store data of a first type.

3. The method of claim 2 wherein allocating the first physical register from one of the at least one queue of available registers to store data of the first type includes mapping an address of the first physical register to an architected register address; and
further comprising storing data of the first type in the first physical register.

4. The method of claim 3 further comprising:
when the data of the first type stored in the first physical register is no longer required to be stored, removing mapping of the address of the first physical register to the architected register address;
placing the first physical register on the one of the at least one queues of available registers; and
during a second time different than the first time, allocating the first physical register to store data of a second type;
wherein allocating the first physical register to store data of the second type includes mapping an address of the first physical register to an architected register address.

5. The method of claim 2 wherein:
forming at least one queue of available physical registers from the at least one array includes:
forming a first queue of available physical registers from the at least one array adapted to store data corresponding to a first thread; and
forming a second queue of available physical registers from the at least one array adapted to store data corresponding to a second thread; and
allocating a first physical register from one of the at least one queue of available registers to store data of a first type includes:
allocating a first physical register from the first queue of available physical registers to store data; and
allocating a first physical register from the second queue of available physical registers to store the same data of the first type.

6. The method of claim 1 further comprising sharing logic between the different types of execution units coupled to one of the at least one array.

7. A processor, comprising:
a plurality of physical registers grouped into at least one array, wherein registers in each of the at least one array share read and write ports; and
at least two types of execution units coupled to each of the at least one array;
the processor is adapted to store different types of data at different times in at least one of the registers from the at least one array, wherein each of the different types of data is associated with at least a different one of the execution units.

8. The processor of claim 7 wherein the processor is further adapted to:
form at least one queue of available physical registers from the at least one array; and
during a first time, allocate a first physical register from one of the at least one queue of available registers to store data of a first type.

9. The processor of claim 8 wherein the processor is further adapted to:
map an address of the first physical register to an architected register address; and
store data of the first type in the first physical register.

10. The processor of claim 9 wherein the processor is further adapted to:
when the data of the first type stored in the first physical register is no longer required to be stored, remove mapping of the address of the first physical register to the architected register address;
place the first physical register on the one of the at least one queues of available registers;
during a second time different than the first time, allocate the first physical register to store data of a second type; and
map an address of the first physical register to an architected register address.

11. The processor of claim 8 wherein the processor is further adapted to:
form a first queue of available physical registers from the at least one array adapted to store data corresponding to a first thread;
form a second queue of available physical registers from the at least one array adapted to store data corresponding to a second thread;
allocate a first physical register from the first queue of available physical registers to store data of the first type; and
allocate a first physical register from the second queue of available physical registers to store the same data.

12. The processor of claim 7 wherein the processor is further adapted to share logic between the different types of execution units coupled to one of the at least one array.

13. A system, comprising:
a memory;
a storage device; and
a processor, coupled to memory and storage device, having:
a plurality of physical registers grouped into at least one array, wherein registers in each of the at least one array share read and write ports; and
at least two types of execution units coupled to each of the at least one array;
the processor is adapted to store different types of data at different times in at least one of the registers from the at least one array, wherein each of the different types of data is associated with at least a different one of the execution units.

14. The system of claim 13 wherein the processor is further adapted to:
form at least one queue of available physical registers from the at least one array; and
during a first time, allocate a first physical register from one of the at least one queue of available registers to store data of a first type.

15. The system of claim 14 wherein the processor is further adapted to:
map an address of the first physical register to an architected register address; and
store data of the first type in the first physical register.

16. The system of claim 15 wherein the processor is further adapted to:
when the data of the first type stored in the first physical register is no longer required to be stored, remove mapping of the address of the first physical register to the architected register address;
place the first physical register on the one of the at least one queue of available registers;
during a second time different than the first time, allocate the first physical register to store data of a second type; and
map an address of the first physical register to an architected register address.

17. The system of claim 14 wherein the processor is further adapted to:
form a first queue of available physical registers from the at least one array adapted to store data corresponding to a first thread;
form a second queue of available physical registers from the at least one array adapted to store data corresponding to a second thread; and
allocate a first physical register from the first queue of available physical registers to store data of the first type; and
allocate a first physical register from the second queue of available physical registers to store the same data.

18. The system of claim 13 wherein the processor is further adapted to share logic between the different types of execution units coupled to one of the at least one array.

19. A method of sharing processor resources, comprising:
grouping a plurality of physical registers into a first array and second array, wherein registers in the first array share read and write ports, registers in the second array share read and write ports, and each of the first and second arrays are coupled to one or more portions of different types of execution units;
allowing a register from the first array to store different types of data at different times; and
allowing a register from the second array to store different types of data at different times.

20. The method of claim 19 wherein:
allowing a register from the first array to store different types of data at different times includes:
forming a queue of available physical registers of the first array; and
during a first time, allocating a first physical register from the queue of available registers of the first array to store data of one of a plurality of data types;
allowing a register from the second array to store different types of data at different times includes:
forming a queue of available physical registers from the second array; and
during the first time, allocating a first physical register from the queue of available registers of the second array to store data of one of a plurality of data types;
allocating a first physical register from the queue of available registers of the first array to store data of one of a plurality of data types includes allocating a first physical register from the queue of available registers of the first array to store data, corresponding to a first thread operated on by a processor, of one of a plurality of data types; and
allocating a first physical register from the queue of available registers of the second array to store data of one of a plurality of data types includes allocating a first physical register from the queue of available registers of the second array to store data, corresponding to a second thread operated on by the processor, of one of a plurality of data types.

21. The method of claim 20 wherein:
allocating the first physical register from the queue of available registers of the first array to store data of one of a plurality of data types includes mapping an address of the first physical register to an architected register address; and
allocating the first physical register from the queue of available registers of the second array to store data of one of a plurality of data types includes mapping an address of the first physical register to an architected register address; and
further comprising:
storing data in the first physical register from the queue of available registers of the first array; and
storing data in the first physical register from the queue of available registers of the second array.

22. The method of claim 21 further comprising:
when the data stored in the first physical register from the queue of available registers of the first array is no longer required, removing mapping of the address of the first physical register to the architected register address;
placing the first physical register on the queue of available registers of the first array; and
during a second time after the first time, allocating the first physical register from the queue of available registers of the first array to store data of a remaining one of the plurality of data types;
wherein allocating the first physical register to store data of a remaining one of the plurality of data types includes mapping an address of the first physical register from the queue of available registers of the first array to an architected register address.

23. The method of claim 21 further comprising:
when the data stored in the first physical register from the queue of available registers of the second array is no longer required, removing mapping of the address of the first physical register to the architected register address;
placing the first physical register on the queue of available registers of the second array; and
during a second time after the first time, allocating the first physical register from the queue of available registers of the second array to store data of a remaining one of the plurality of data types;
wherein allocating the first physical register to store data of a remaining one of the plurality of data types includes mapping an address of the first physical register from the queue of available registers of the second array to an architected register address.

24. The method of claim 21 wherein storing data in the first physical register from the queue of available registers of the second array includes writing data stored in the first physical register from the queue of available registers of the first array to the first physical register from the queue of available registers of the second array.

25. The method of claim 19 further comprising sharing logic between the different types of execution units coupled to the first and second arrays.
